(19) United States
(12) Patent Application Publication
(10) Pub. No.: US 2026/0184860 A1
(43) Pub. Date: Jul. 2, 2026

(54) ELASTIC COMPONENT OF PAVEMENT STRUCTURE MADE FROM AGED RUBBER PARTICLES

(71) Applicants: Polytex Sportbelage Produktions-GmbH, Grefrath (DE); FormaTurf GmbH, Essen (DE)

(72) Inventors: Stephan SICK, Baden-Baden (DE); Dario GROCHLA, Bochum (DE); Thorsten VAN DEN BERG, Essen (DE); Frank LUCARELLI, Zelienople, PA (US); Sven HAMANN, Mühlheim (DE)

(73) Assignees: Polytex Sportbelage Produktions-GmbH, Grefrath (DE); FormaTurf GmbH, Essen (DE)

(21) Appl. No.: 19/002,997

(22) Filed: Dec. 27, 2024

(51) Int. Cl. C08J 3/24; C08J 3/20

(52) U.S. Cl. CPC C08J 3/24; C08J 3/20; C08J 2375/04; C08J 2417/00

(57) ABSTRACT

Disclosed herein is an elastic component (404) of a sports floor (400, 500, 600). The component comprises: aged rubber particles (204); and a PU matrix (302) that comprises the rubber particles, the PU matrix being the reaction product of a PU-rubber reaction mixture (300) comprising the aged rubber particles, a PU binder composition (206) and a plasticizer (210).

### FIELD OF THE INVENTION

The invention relates to elastic components of a sports floor such as shock pads or cushioning layers of sports floors and for a method of manufacturing the same.

### BACKGROUND

Elastic floorings, such as those used for sports grounds (e.g., athletic tracks) or playgrounds, are commonly made of polyurethane (PU). These floorings may be installed by unrolling a prefabricated PU mat at the destination and gluing the mat to the floor using a polyurethane adhesive. Some systems also allow for the generation and application of a PU binder directly at the installation site (“in situ”), reducing transport costs and simplifying the installation process. For instance, the PU binder can be foamed into PU foam on-site, either mechanically or chemically, as described in EP3480230A1.

In order to increase the mechanical stability of these elastic sports floors, it is also known to add rubber particles to the PU binder before the binder is cured. For example, EP3480230A1 describes the combination of a PU-binder and rubber particles that may be derived from old tires to form an elastic sports floor layer. This document also discloses a mixture with a prepolymer that comprises a process oil in small amounts (an amount of 10%-15% by weight of an initial mixture comprising a polyol component and MDIs), which corresponds to a rubber:oil ratio in a final mixture of about 3% to 5% in a 30% PU-binder, 70% rubber particle composition.

### SUMMARY OF THE INVENTION

It is an objective to provide an improved elastic sports floor component and method for manufacturing the same. The objectives underlying the invention are solved by the features of the independent claims.

In one aspect disclosed herein is a method of manufacturing an elastic component of a sports floor, the method comprising: mixing aged rubber particles with a PU binder composition and a plasticizer to provide a PU-rubber reaction mixture; and allowing the PU-rubber reaction mixture to cure to provide the elastic component.

In a further aspect, disclosed herein is an elastic component of a sports floor. The component comprises: aged rubber particles; and a PU matrix that comprises the rubber particles. The PU matrix is formed by a PU-rubber reaction mixture comprising the aged rubber particles, a PU binder composition and a plasticizer.

It is understood that one or more of the examples described herein may be combined as long as the combined examples are not mutually exclusive.

### BRIEF DESCRIPTION OF THE DRAWINGS

In the following, examples are described in greater detail making reference to the drawings in which:

FIG. 1 is a flow chart of a method of manufacturing an elastic component of a pavement structure;

FIG. 2 illustrates individual components of a PU-rubber reaction mixture before they are mixed;

FIG. 3 illustrates the mixed PU-rubber reaction mixture;

FIG. 4 illustrates a sports floor component configured as a support layer within a sports floor system;

FIG. 5 illustrates a sports floor in the form of a running track; and

FIG. 6 illustrates a sports floor in the form of a shock pad.

### DETAILED DESCRIPTION

Manufacturing or using an elastic component as specified above may offer several technical advantages:

The inventors have observed that, in some cases, when the aged rubber is particularly old and worn out, the rubber particles become very brittle and mechanically unstable. This can result in reduced elasticity of the elastic component and a shortened lifespan of the product. The rubber particles may crumble under heavy loads and impacts, which are typical for products intended as sports floor components. Consequently, the elastic component will not only exhibit lower elasticity compared to a product made from virgin rubber particles, but it will also lose its mechanical stability. As the elastic layer deteriorates, its already limited ability to dampen impacts from balls, players, and other loads diminishes further. This may cause secondary damage to other components or layers positioned above or below the elastic component.

Particularly when using rubber particles from old tires or other waste rubber sources, the exact age and degree of degradation of the aged rubber particles can be difficult to ascertain. Any batch of aged rubber particles may include a mix of particles with varying degrees of aging and mechanical properties.

The inventors have surprisingly observed that adding a comparatively large amount of a plasticizer, particularly one or more oils, to the PU-rubber reaction mixture comprising the aged rubber particles can mitigate or overcome the problems of decreased elasticity and mechanical instability of aged rubber particles. This approach can also help prevent premature aging and decay of the elastic component. It is no longer necessary to use virgin rather than aged rubber particles, or to use a mix of aged and virgin rubber particles in order to achieve a desired degree of elasticity. This will help avoiding the generation of plastic waste, because aged rubber can be re-used in new products.

Without being bound by theory, the inventors hypothesize that the increased brittleness of aged rubber particles results from the loss of plasticizers over time during use. By incorporating large amounts of a plasticizer into the PU-rubber reaction mixture containing the aged rubber particles, the plasticizer, which does not participate in the polymerization reaction, migrates into the aged rubber particles, thereby restoring or at least approximating their original elasticity.

The inventors have observed that prior art PU-binders either do not comprise plasticizers or include oils in insufficient quantities to significantly improve the elasticity of aged rubber particles. In many products, the rubber particles represent the largest weight fraction, so adding only a small percentage of oil to the PU-binder is inadequate to noticeably enhance the elasticity of the aged rubber particles.

For example the weight ratio of the plasticizer to the rubber particles in the PU-rubber reaction mixture is at least 5:100, in particular at least 10:100, in particular at least 15:100, in particular at least 20:100, e.g., at least 30:100, e.g. 10:100 to 35:100.

This may ensure that the elasticity, mechanical stability and life expectancy of the resulting elastic component is similar or even identical to a corresponding elastic component made of virgin rubber particles.

The inventors have observed that the plasticizer is absorbed by the aged rubber particles, functionally replacing the oils that may have originally been present in the rubber but lost over time due to oxidation. The oxidation or migration of these original oils causes the rubber to progressively shrink and harden throughout its lifetime. By adding the aged rubber particles into the PU-rubber reaction mixture and exposing them to the plasticizer, the aged rubber particles absorb the plasticizer, swell, and soften. This process restores their elastic properties, bringing them closer to the original physical characteristics of virgin rubber.

The plasticizer can in particular be an oil or a combination of two or more oils. For example, the plasticizer can be selected from a group comprising: a naphthenic oil; an aromatic oil; a paraffinic oil; a vegetable oil, in particular soy bean oil, sunflower oil, palm oil; diisononyl phthalate (DINP); 1,2-Cyclohexane dicarboxylic acid diisononyl ester (DINCH); Stearic acid; Metal salts of stearic acid, e.g., zinc or calcium salts of stearic acid; and combinations thereof. The naphthenic, aromatic and paraffinic oil may be of low, medium or high viscosity.

According so some examples, the plasticizer has medium or high viscosity, assuming the following thresholds for the viscosity (measured as viscosity index, VI, in cSt):

| | VI of Low Viscosity | VI of Medium | VI of High |
|---|---|---|---|
| | Plasticizer | Viscosity | Viscosity |
| Plasticizer, | <35 St | Between 35 and 80 | >80 cSt |
| e.g., oil | | cSt | |

In some cases, the plasticizer has a viscosity index of at least 80 cSt or at least 100 cSt, or higher.

The inventors have observed that high viscosity plasticizers, e.g., naphthenic medium viscosity oils, naphthenic high viscosity oils, and in particular mixtures of medium and high viscosity naphthenic oils, are particularly suited for efficiently migrating into the aged rubber particles and at the same time to increase the elasticity and mechanical stability of the particles. These types of oils have been shown to be sufficiently immobile as not to migrate out of the elastic component during its normal usage time. For example, the mixture of medium and high viscosity naphthenic oil may be a 1:3 to 3:1 mixture by weight, e.g., a 1:1 mixture.

All viscosity values specified herein are measured using a capillary viscometer (Ostwald or Ubbelohde Viscometers). A specific volume of the plasticizer, typically an oil, is allowed to flow through a calibrated glass capillary tube under gravity. The time taken for the fluid to flow between two marked points is measured. Kinematic viscosity (in cSt) is calculated using the formula: v=K×t, wherein v=Kinematic viscosity (cSt), K=Calibration constant of the viscometer, and t=Flow time (seconds). The measurements are performed at 40° C. and 100° C. The measurements are performed in accordance with ASTM D445.

The aged rubber particles can be, for example, aged rubber particles selected from a group comprising:
crumb rubber;
aged EPDM particles;
aged styrene-butadiene rubber, SBR, particles;
aged rubber infill of artificial grass;
particles obtained from shredding aged elastic component of a rubber-based floor pavement structure; and
combinations thereof.

Crumb rubber is a finely ground rubber material derived from recycled rubber products, such as tires, and processed into small, granules or particles. It is commonly produced through mechanical grinding or cryogenic processing. While crumb rubber, along with most of the aforementioned rubber types, is inexpensive and readily available, these materials pose challenges. Prolonged use, particularly under harsh outdoor conditions, can lead to aging of rubber particles, resulting in elastic components with diminished elasticity, mechanical stability, and overall durability if these components incorporate these aged rubber particles without customization of the PU-rubber reaction mixture.

According to some examples, the aged rubber particles are selected or pre-processed such that at least 2%, in particular at least 3.5%, in particular at least 5% by weight of the aged rubber particles have a particle size of less than 0.5 mm.

In addition, or alternatively, the aged rubber particles may be pre-treated prior to being added to the mixture to ensure that the weight fraction of particles with a size of less than 0.5 mm within the total aged rubber particles is increased to, or maintained at, at least 2% by weight, in particular at least 3.5% by weight, in particular at least 5% by weight.

For example, the rubber particles may be dried prior to being added to the mixture to achieve a controlled moisture content, as the moisture level can influence the PU polymerization reaction. Drying should be conducted in a manner that preserves the proportion of small particles, ensuring it does not fall below the specified threshold. For instance, when drying with an air stream, small sieves can be used to retain the smaller particle fraction.

In some cases, it may even be feasible to increase the proportion of small particles by blending two different batches of aged rubber particles. For example, a batch with a small particle fraction below the threshold can be combined with another batch from a different source with a small particle fraction well above the threshold. This approach ensures the combined material meets or exceeds the required small particle proportion.

Additionally, or alternatively, aged and brittle rubber particles can be tumbled or subjected to mechanical or abrasive treatment. These processes can break down larger particles, increasing both the number and weight share of smaller rubber particles within the batch.

The inventors have observed that the above-mentioned fraction of very small particles is highly beneficial in this context, because these particles significantly increase the viscosity of the PU-rubber reaction mixture.

Having a PU-rubber reaction mixture with higher viscosity allows reducing the NCO content of the reaction mixture, and thereby increasing elasticity of the resulting, hardened PU-matrix, without risking that the PU-rubber reaction mixture will collapse before adequate curing is achieved: The PU-rubber reaction mixture contains gas inclusions, which may result from the ongoing reaction and/or may be actively introduced in the PU-rubber reaction mixture, e.g., by foaming additives or mechanical foaming equipment. The gas inclusions may collapse before adequate curing is achieved if the viscosity of the PU-rubber reaction mixture is too low. A prematurely collapsed polyurethane (PU) reaction mixture contains insufficient gas inclusions, resulting in reduced elasticity of the hardened PU matrix. To address this, prior art has employed a relatively high NCO content in the PU binder to ensure rapid curing. However, this approach has the drawback of decreasing the elasticity of the resulting PU matrix as the NCO content increases. The inventors have surprisingly determined that ensuring that the aged rubber particles comprises a significant fraction of very small rubber particles, the viscosity of the reaction mixture is increased, enabling a reduction in NCO content without premature collapse. This adjustment enhances the elasticity of the PU matrix formed during polymerization. Consequently, any losses in elasticity due to the aging of rubber particles can be mitigated and, in some cases, even overcompensated, by the reduced NCO content, which is possible thanks to the increased viscosity provided by the fraction of very small aged rubber particles.

Particles derived from aged, used rubber often contain a significant proportion of very small particles, which are formed through abrasion and other mechanical wear during their service life, and which may also be formed when the aged tires, rubber-based support mats, shock pads, etc. are shredded to obtain the aged rubber particles. In contrast, particles made from fresh rubber typically have a much lower fraction of such small particles, because fresh rubber is more elastic, more robust against shear forces. Many aged rubber particle products available on the market lack this fraction of very small particles, or it constitutes only a very small portion. This is because small particles are often removed by filtration, for example, to prevent dust formation during subsequent processing. Additionally, the smallest particles may be lost as a side effect of the production and further processing of rubber particles, even without active filtration steps.

The inventors have identified that retaining the fraction of the smallest rubber particles is highly beneficial in producing elastic components from aged rubber particles and a PU-binder. These small particles increase the viscosity of the reaction mixture, preventing premature collapse and enhancing elasticity of the cured elastic component by incorporating more air voids into the cured PU matrix. Notably, the fraction of particularly small rubber particles contributes to increased elasticity also indirectly by enabling a reduction in the NCO content of the PU-rubber reaction mixture. This results in a lower degree of cross-linking during polymerization, further improving elasticity.

According to some examples, the elastic component of the sports floor is selected from a group comprising:
a rubber tile for a sports floor;
a damping layer of a sports floor, in particular of a running track or tennis court;
an elastic support mat to be installed below, within or on top of a sports floor;
a stable mat for animals, in particular a stable mat for horses;
an elastic mat to be reversibly placed on top a sports floor, in particular a bumper plate for weight lifting, protective layers, or a gymnastic mat;
acoustic layers; and
combinations thereof.

According to some examples, the PU-binder composition comprises a polyol component and an isocyanate component. The curing comprises allowing the polyol component and the isocyanate component to undergo a polymerization reaction to form a PU matrix that comprises the rubber particles.

For example, the isocyanate component can comprise an aromatic or aliphatic multifunctional (>=2-NCO groups) isocyanate. The polyol component can comprise a multifunctional (>=2-OH groups) polyol.

According to other examples, the PU-binder composition comprises an NCO-prepolymer. The curing comprises allowing the prepolymer to undergo a polymerization reaction to form a polyurethane matrix that comprises the rubber particles.

An NCO prepolymer is a type of prepolymer used in polyurethane (PU) synthesis, characterized by having isocyanate (—NCO) groups at the ends of its molecular chains. It is formed by reacting a polyol with an excess of isocyanate, leaving unreacted NCO groups in the resulting product. The prepolymer may undergo the polymerization reaction under the presence of water, which may be added to the PU-rubber reaction mixture in liquid form or may be provided in the form of moisture comprised in the surrounding air and/or comprised in other components of the PU-rubber reaction mixture, e.g., as moisture comprised in the aged rubber particles.

According to one example, the NCO-prepolymer is a reaction product of a diol and MDI. The diol may have, for example, an average molecular weight of 1000 to 4000 g/mol. The diol can be, for example, a Polypropylene glycol, e.g., PPG2000. The “2000” in PPG2000 Diol indicates its average molecular weight (g/mol).

Polypropylene glycol is composed of repeated units of propylene oxide (PO). The terminal hydroxyl groups make it reactive, enabling it to participate in polymerization reactions with isocyanates. Being a diol, it has two reactive hydroxyl groups, allowing it to form linear polyurethane chains or lightly cross-linked networks. The inventors have observed that polyols in the above-mentioned weigh ranges, and in particular PPG in this molecular weight range, result in favorable elasticity and other mechanical properties of the resulting, hardened PU matrix.

According to some examples, the prepolymer of the PU-binder composition can be produced as described for example in EP3480230A1 which is hereby included by reference in its entirety.

According to some examples, the PU-binder composition has an NCO content of less than 11%, in particular less than 8%, in particular less than 5%, in particular of 4% to 10%, e.g., 7% to 9%. The NCO content is defined as:

$$\frac{weight of NCO groups in the PU - binder composition}{total weight of the PU - binder composition} \times 100 [ \% ] .$$

The specified NCO ranges represent a particularly low NCO content, which offers the advantage of producing a flooring component with exceptionally high elasticity. Generally, an increase in NCO content results in a stronger polymerization reaction but reduces elasticity, which is typically undesirable when manufacturing elastic components for sports flooring. However, the inventors have observed that the presence of very small rubber particles increases the viscosity of the reaction mixture sufficiently, allowing for a reduction in the NCO content of the PU-rubber reaction mixture.

When the polyol and isocyanate components are mixed, or when an NCO prepolymer is brought in contact with water, a chemical reaction (polymerization) is initiated to form polyurethane. The ratio of polyol to isocyanate, to be more particular, the ratio of free —OH groups and free NCO-groups, controls the curing process and final properties of the PU-matrix, which is also referred to as PU-binder.

Also described herein is an elastic component of a sports floor. The elastic component comprises: aged rubber particles; and a PU matrix that comprises the rubber particles, the PU matrix having been formed by a PU-rubber reaction mixture comprising the aged rubber particles, a PU binder composition and a plasticizer.

Also described herein is an elastic component of a pavement structure. The pavement structure can be, for example, a sports floor, a pedestrian pathway, a bicycle pathway, or a residential flooring, particularly an industrial flooring. The elastic component comprises: aged rubber particles; and a PU matrix that comprises the rubber particles, the PU matrix having been formed by a PU-rubber reaction mixture comprising the aged rubber particles, a PU binder composition and a plasticizer.

Preferably, the weight ratio of the plasticizer to the rubber particles in the elastic component is at least 5:100, in particular at least 10:100, in particular at least 15:100, in particular at least 20:100, e.g. 10:100 to 35:100.

According to some examples, at least 2%, in particular at least 3.5%, in particular at least 5% by weight of the aged rubber particles have a particle size of less than 0.5 mm.

Also described herein is a sports floor comprising the elastic component described herein for various examples of the invention.

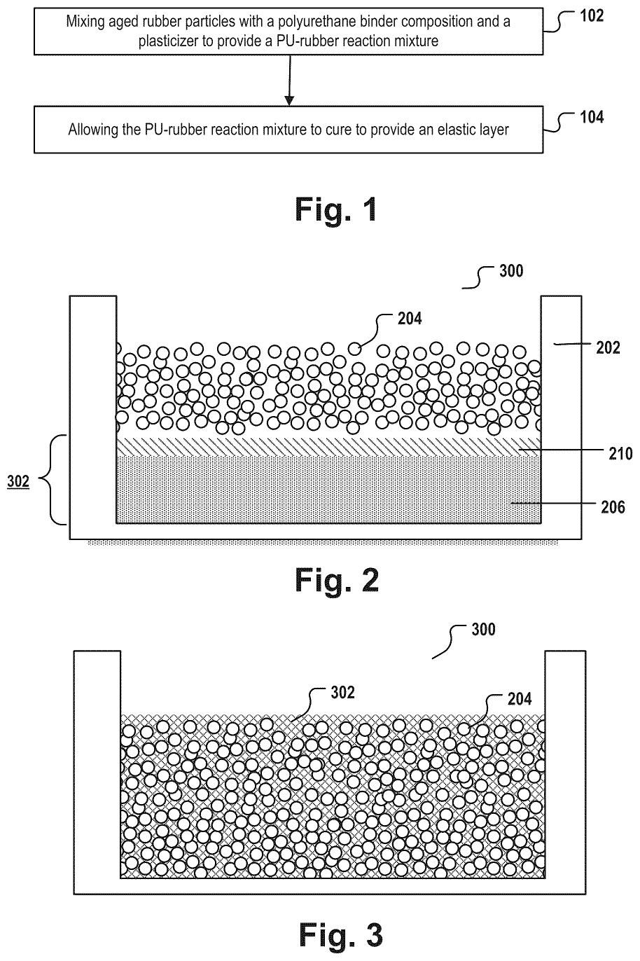

FIG. 1 is a flow chart of a method of manufacturing an elastic component of a pavement structure.

The method comprises a step 102 of mixing aged rubber particles with a plasticizer and a PU binder composition to provide a PU-rubber reaction mixture, also referred to herein as “PU reaction mixture” or “reaction mixture”, as depicted in FIGS. 2 and 3. The mixture may then be cast onto the installation site or into a mold or may be applied as an additional PU layer onto an existing, sheet-shaped object. The method further comprises a step of allowing the PU-rubber reaction mixture to cure to provide an elastic layer.

In the following, an example of this method will be described in greater detail for an example where the PU binder composition 206 is a 1C PU system with a prepolymer that is cast onto the installation site, e.g. for providing a support layer of a running track, playground or sports field.

For on-site generation of a PU-based elastic layer, a user utilizes a portable apparatus equipped with a reaction tank containing a mixer connected to a nozzle via a duct. The system applies a PU-rubber reaction mixture 300 as shown in FIG. 3. The PU-rubber reaction mixture can be stored in a single container or in separate containers for different components. For example, one container may hold the PU-rubber reaction mixture, while a second contains rubber granules or other additives, which can be combined during mixing. The plasticizer may be comprised e.g. in the container comprising the aged rubber particles, or in the container with the prepolymer mixture. Preferably, the PU-binder component is a 1C PU system comprising an NCO prepolymer. The rubber particles may comprise some moisture. When the PU binder composition is mixed with the moist rubber particles, the PU-rubber reaction mixture slowly begins to cure. Before the mixture becomes too viscous, it is applied on the ground. The resulting elastic PU layer typically has a thickness of 1 to 5 cm. Wetting the base layer with water before application is optional, as ambient humidity or moisture from the base layer and/or the rubber particles is often sufficient to initiate curing. When the prepolymer mixture interacts with moisture from the air, base layer, or added components, CO2 and polyurethane polymers are produced, creating an elastic, foamed PU layer.

The mixed PU-rubber reaction mixture has viscosity that is sufficiently low to enable self-leveling into a smooth layer, filling uneven surfaces, cracks, and depressions. The viscosity is carefully balanced and sufficiently viscous to allow the retention of CO2 bubbles, enabling the formation of PU foam. The curing process typically completes within 1 to 15 hours, depending on temperature and weather conditions.

Once mixed, the supplemented prepolymer mixture begins to generate polyurethane polymers and CO2 bubbles, forming the foam. The mixture is then transported through the nozzle and applied directly onto the ground in lanes to cover large areas. While primarily used outdoors, this method can also be employed for indoor sports fields. After curing and drying, the PU foam forms a durable elastic flooring suitable for sports applications.

The flooring may optionally be coated with a protective, water-repellent layer, such as a PU varnish, to enhance resistance to UV light, heat, moisture, and fungi, or to provide a specific color. Application of the prepolymer mixture should occur within 30 minutes of mixing, as foam generation starts immediately. During this process, the mixture remains liquid enough to penetrate small cracks, mechanically anchoring the PU layer to the base. This eliminates the need for additional leveling layers and ensures the foam conforms to surface irregularities, forming a seamless, durable flooring.

This system enables the creation of extensive, continuous sports flooring that adapts to surface irregularities and adheres firmly to the ground without requiring an adhesive layer. The process can be performed within a wide temperature range, ensuring versatility in different climates and conditions.

The on-site manufacturing of the elastic component may also be referred to as “wet pour system”. Preferably, the PU binding composition is a 1C PU system, also known as “moisture cured system”, which comprises an NCO-prepolymer. 1C PU systems may have the advantage of a prolonged curing time, allowing the reaction mixture to completely level before the curing prevents any further movement of the PU reaction mass. For example, the 1C PU system may be used for creating elastic layers in sport- and running tracks, elastic layers for artificial turf, and elastic layers for playgrounds.

For example, the prepolymer of the 1C PU system can be manufactured in a manufacturing facility by creating a mixture of 2,2′, 2,4′ and 4,4′ MDI monomers. This MDI mixture is transferred into a reactor and heated to 30° C. Hereafter the polyol(s) of the polyol component are added stepwise and are mixed under stirring in a temperature in a range of 40° C.-60° C., preferably 40° C.-45° C. Further possible additives are, for example, extenders and rheology modifiers are added under stirring. This prepolymer mixture is used as the (1C PU) PU-binder composition 206 shown in FIG. 2.

According to a different approach, the elastic layer is manufactured in a manufacturing facility and then transported to the use-site. Often, a 2C PU system is used in this case.

A “1C PU System (One-Component Polyurethane System)” as used herein is a polyurethane system that cures through exposure to ambient moisture or humidity. It comprises an NCO-pre-polymer and is ready to use, requiring no additional mixing or components.

A “2C PU System (Two-Component Polyurethane System)” as used herein is a polyurethane system composed of two separate components—a polyol and an isocyanate—that are mixed together prior to application, initiating a chemical reaction that cures the material.

An example for a manufacturing approach in a manufacturing facility is compression molding:

In a manufacturing facility, a polyol component and an isocyanate component, which can react to form a cured polyurethane matrix, are stored in separate containers under controlled conditions to prevent premature reactions. Both components should be brought to the specified processing temperature before mixing. The aged rubber particles, and other optional additives, if used, may be pre-conditioned to ensure they are free from excess moisture. If the rubber particles are dried, the drying process is preferably implemented such that the fraction of the smallest rubber particles are not lost. The two components, the plasticizer and the aged rubber particles, are metered in precise ratios and fed into a mixer, e.g., a high-shear mixer. Rubber granules, the plasticizer and optionally also fillers are introduced into the mixture during this process. The mixing ensures a homogenous distribution of all materials, preparing the reaction mixture for casting.

Once thoroughly mixed, the 2C PU reaction mixture is poured into molds designed to shape the sport floor components. The molds may be pre-treated with a release agent to ensure easy demolding after curing. The mixture flows into the mold cavities, self-leveling to fill all spaces and form a uniform layer.

The chemical reaction between the polyol and isocyanate begins immediately upon mixing. If moisture is present, it can further enhance the foaming process by releasing CO2. The curing conditions, including temperature and humidity, are carefully controlled to optimize the reaction and ensure the polyurethane solidifies with the desired elastic and mechanical properties. The curing process typically completes within several hours, depending on the formulation and environmental conditions. The PU foam forms a strong, flexible matrix that integrates the aged rubber particles, and optionally also fillers, resulting in a durable and elastic sport floor component.

After the curing process is complete, the components are removed from the molds. The solidified PU material retains its designed shape and elastic properties. The finished components can be coated with a protective and decorative layer, such as a polyurethane varnish, to improve durability and resistance to wear, UV light, and moisture. This coating also allows for customization of the surface color and texture.

According to one example, the mold and the elastic component obtained therefrom may have the shape of a tile. The reaction mixture in the mold is then allowed to cure under heat and compression. The resulting product may be used, for example, as elastic tiles or mats, horse stable mats, bumper plates for weight lifting, acoustic layers, or protective layers.

The polyol used for providing the polyol component in a 1C PU system or for synthesizing the pre-polymer of a 1C PU system can be, for example, one or more of the following polyols: PPG1000 Diol, PPG2000 Diol, PPG3000 Triol, PPG4000 Diol, PPG5000 Triol, PPG6000 Triol, Polybutadiene Diol, etc. These polyols may alternatively be used as the polyol component of a 2C PU system.

In addition, or alternatively, the isocyanates used for providing the isocyanate component in a 1C PU system or for synthesizing the pre-polymer of a 1C PU system can be, for example, one or more of the following isocyanates: aromatic Isocyanates such as Methylene diphenylisocyanate (MDI) or Toluene diisocyanate (TDI), or aliphatic Isocyanates, such as Hexamethylene diisocyanat (HDI), HDI Uretdione, HDI Isocyanurate, or Isophorone diisocyanate (IPDI). The MDIs may be monomeric MDI (mMDI) such as 4,4′ MDI, 2,2′ MDI or 2,4′ MDI, or polymeric MDI (pMDI). —The TDI can be, for example, 2,4′ TDI or 2,6′ TDI.

An example of a PU-rubber reaction mixture used for manufacturing an elastic component according to an embodiment of the invention (“example 1”) and its beneficial effects in comparison to a conventional PU-rubber reaction mixture (“control mixture”) are presented in the following:

| Components | Example 1 Mixture (1C PU-system) | Control Mixture (1C PU-system) |
|---|---|---|
| PU-binder | NCO Prepolymer produced from | NCO Prepolymer produced from |
| composition | PPG2000 Diol and MDI, NCO- | PPG2000 Diol and MDI, NCO-content: |
| | content: 8% | 10% |
| | 10 parts per weight PU-binder | 10 parts per weight PU-binder |
| | composition per 100 parts aged | composition per 100 parts aged rubber |
| | rubber particles; | particles; |
| Plasticizer | 1:1 mixture of napthenic medium | none |
| | viscosity oil and high viscosity oil; | |
| | 19 parts per weight the plasticizer | |
| | per 100 parts per weight the rubber | |
| | particles | |
| Aged rubber | Aged rEPDM in wet pour conditions; | Aged rEPDM in wet pour conditions; |
| particles | | |

The rEPDM (Recycled Ethylene Propylene Diene Monomer) is recycled, aged EPDM, e.g., post-industrial and/or post-consumer EPDM.

| | Example 1 | Control |
|---|---|---|
| Properties of elastic component made of cured PU mixture | Mixture | Mixture |
| Hardness (the surface resistance of the material to | 70.33 | 78.67 |
| deformation): While it does not directly measure elasticity, | | |
| there is an inverse relationship between hardness and elasticity | | |
| in many cases. A harder material typically exhibits less flexibility | | |
| and elasticity, while a softer material allows for greater elastic | | |
| deformation. | | |
| Tensile strength [MPa] Tensile strength refers to the maximum | 0.91 | 0.63 |
| stress the material can withstand when stretched before | | |
| breaking. A material with high elasticity often has good tensile | | |
| strength within the elastic deformation range. However, | | |
| excessive elasticity (too soft) might reduce tensile strength, as | | |
| the material deforms more easily and reaches its breaking point | | |
| faster. | | |
| Force reduction [%] Force reduction measures the material's | 30 | 13 |
| ability to absorb impact or reduce transmitted force. Higher | | |
| elasticity correlates with higher force reduction, as elastic | | |
| materials deform to dissipate energy. This parameter is | | |
| particularly important in applications like sports flooring or | | |
| cushioning systems. | | |
| Energy restitution [%] | 67 | 77 |

As can be derived from the comparative example above, the adding of the plasticizer in high amounts results in a significant reduction in hardness, an increase in force reduction (dampening effect), and a reduced energy restitution. As a consequence, more energy gets dissipated by the replastified rubber and the elasticity increases. The comparative example also shows a superior bonding of the aged rubber particles to the PU-binder as indicated by the higher tensile strength value.

Curing conditions can be in a wide range from room temperature, in particular for 1C PU systems applied at the installation site, to higher temperatures up to 75° C., typically used in manufacturing facilities using 2C PU systems. The curing can take place with relative humidity from 30-80%.

FIG. 2 illustrates the individual components of a PU-rubber reaction mixture 300 contained within a container 202, such as a mixer, before the components are mixed. The reaction mixture includes at least the plasticizer 210, aged rubber particles 204, and a PU binder composition 206. Additionally, the mixture may incorporate various optional additives, such as fillers, pigments, UV-protecting agents, and antioxidants, depending on the application requirements.

The PU binder composition 206 and plasticizer together form the liquid fraction of the mixture, while the aged rubber particles constitute the solid fraction. Once homogeneously mixed, the PU-rubber reaction mixture is poured into a mold or onto the installation site and subsequently cured. The curing conditions are preferably selected to allow the mixture to fully level out and fill all cavities of the mold or installation site before solidifying into the final structure.

FIG. 3 illustrates the mixed PU-rubber reaction mixture after the completion of homogeneous mixing, just prior to being cast onto the installation site or into a mold. The particles 204 are uniformly dispersed within the liquid fraction 302, which will subsequently cure into a solid PU matrix. As a result, the final elastic component may include or consist of a cured PU matrix embedding the aged rubber particles. Additionally, the elastomeric component may contain various air-filled cavities, with the volume of these cavities determined by the weight (or volume) ratio of the liquid fraction 302 to the rubber particles. A lower proportion of the liquid fraction serving as the PU binder results in larger cavity volumes. These air-filled cavities can further enhance the elasticity of the elastic component.

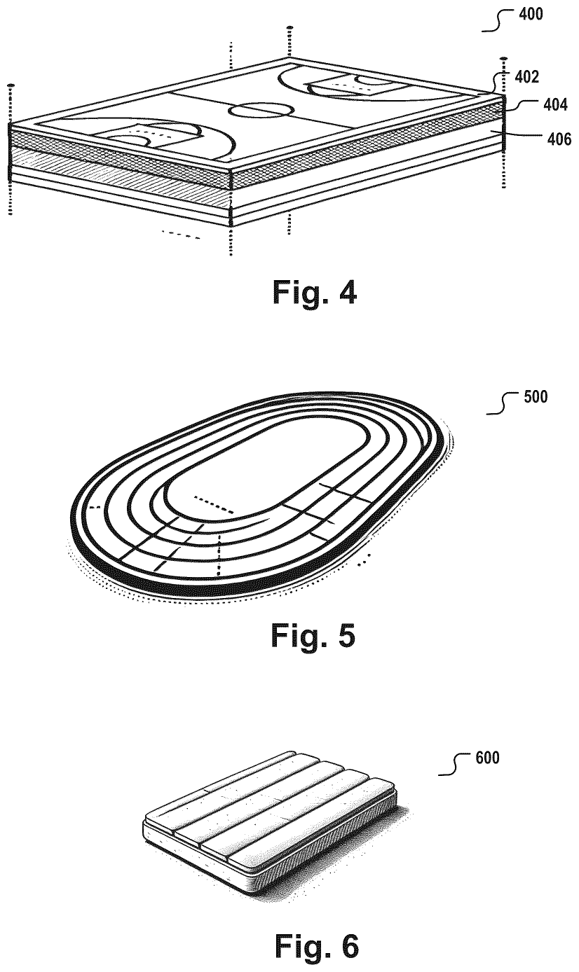

FIG. 4 illustrates a sports floor 400, which can be used for indoor or outdoor sports such as soccer, handball, or football. The sports floor may comprise multiple layers. For example, the top layer 402, also referred to as the playing surface layer, serves as the primary interface for athletes, providing grip, comfort, and durability. Depending on performance requirements such as shock absorption, ball bounce, and wear resistance, the playing surface layer may be made of materials such as polyurethane or acrylic coatings (e.g., for indoor courts like basketball or badminton), synthetic turf, or rubber for landscaping, playgrounds, or multi-sport surfaces.

The support layer 404 functions as a shock absorption layer. This elastic component is manufactured from a reaction mixture comprising a PU binder composition, a plasticizer, and aged rubber particles. It provides elasticity, absorbs and distributes impacts, reduces stress on athletes' joints and muscles, and enhances the lifespan of the top layer.

The support layer 404 may be installed directly on the ground, which may consist of materials such as rock, soil, or sand. In other cases, the support layer 404 is installed on an additional intermediate layer, the base layer 406. The base layer provides a level, firm surface to support the upper layers. For outdoor applications, the base layer 406 is typically made of concrete or asphalt, while for indoor sports flooring, it may consist of engineered plywood or particleboard. In these configurations, the base layer 406 is the layer directly installed on the ground.

FIG. 5 illustrates a sports floor in the form of a running track 500. The topmost layer, the running surface layer, may have a similar function like the surface layer 402 illustrated in FIG. 4. The running track 500 also comprises a support layer below this topmost layer. The support layer is an elastic component manufactured from a reaction mixture comprising a PU binder composition, a plasticizer, and aged rubber particles as described herein for examples of the invention. The support layer may be manufactured in a factory, e.g., by manufacturing elastic tiles or mats which are transported to and installed at the use site. In other examples, the support layer is created on-site, e.g., by creating the PU-rubber reaction mixture at the use site and applying and spreading the PU-rubber reaction mixture on the ground or an intermediate layer to allow the PU-rubber reaction mixture to cure on-site. An example of the on-site installation process is described in the above-referenced patent application EP3480230A1.

FIG. 6 illustrates a sports floor in the form of a shock pad 600. A shock pad as used herein is a cushioning layer or cushioning tile installed beneath the surface material (e.g., artificial turf, rubber tiles, or synthetic flooring) or used as the topmost surface layer. In the latter case, a shock pad is often also referred to as impact protection layer and used e.g. for playgrounds. The shock pad may be installed, or, for some applications, may be a mobile mat that is reversibly and only temporarily placed on top of an existing sports floor. Its primary function is to absorb impact, enhance safety by reducing the risk of injuries from falls, and improve surface performance by providing shock absorption, energy return, and uniform support. A shock pad may be made completely or partially from a reaction mixture comprising a PU binder composition, a plasticizer, and aged rubber particles as described herein for examples of the invention.

A “sports floor” as used herein refers to a surface designed to support athletic and recreational activities, including playgrounds, recreational areas, horse arenas and equestrian tracks. In particular, the support may be provided by providing durability, safety, and performance in accordance with the requirements of the respective application. It includes a range of systems such as artificial turf, rubber tiles, hardwood courts, and synthetic surfaces used in sports fields, indoor courts, and playgrounds. In the context of playgrounds, sports flooring also prioritizes impact absorption and safety to minimize injuries from falls while maintaining durability and weather resistance for outdoor environments. The sports floor may be an indoor or outdoor pavement system that is either reversibly or irreversibly attached to, integrated in, or placed or installed on top of, the ground. A sports floor can be, for example, an indoor or outdoor sports floor. Such structures may be specifically designed for indoor or outdoor use and are suitable for applications including sports fields, sports hall flooring, playgrounds, or park surfaces. The sports floor may be a product intended to constitute the flooring system, or to be either reversibly or irreversibly integrated into or affixed to the flooring system or ground of a sports facility or playground. It is designed to provide a functional, elastic, and durable surface for various applications, particularly different types of sports. A sports floor typically comprises multiple layers, each serving a distinct purpose to ensure stability, durability, and performance. One or more of these layers may be an “elastic component”, as its function, either alone or in combination with other layers, is to provide the necessary elasticity for the sports floor.

An “elastic component” as used herein refers to an elastic part of a sports floor, which may take the form of a layer or any other shape. In some instances, the elastic component itself may constitute the entire sports floor. For example, a shock pad, protective pad, or gymnastic mat comprising a single sheet formed by a cured polyurethane (PU) matrix with embedded rubber particles may serve as the sports floor.

A “polyol component” as used herein is a substance or substance mixture comprising a polyol, i.e., a compound with multiple hydroxyl (—OH) groups, which serves as the primary building block in the polyurethane structure. The polyol determines the mechanical properties, flexibility, and durability of the resulting polyurethane. For example, the polyol component may comprise polyether polyols and/or polyester polyols. The polyether polyols may be derived, for example, from ethylene oxide or propylene oxide, offering flexibility and good hydrolytic stability. Polyester polyols are derived from diacids and diols, offering higher strength and chemical resistance.

An “isocyanate component” as used herein is a substance or substance mixture comprising an isocyanate. Isocyanates are reactive compounds containing one or more isocyanate (—NCO) groups that react with the hydroxyl groups in the polyol to form urethane bonds. The isocyanate determines the reactivity and cross-link density of the polyurethane, which affects hardness/elasticity, chemical resistance, and mechanical strength.

While the invention has been illustrated and described in detail in the drawings and foregoing description, such illustration and description are to be considered illustrative or exemplary and not restrictive; the invention is not limited to the disclosed examples.

### REFERENCE SIGNS LIST

102-104 Steps
202 Container/mixer
204 Aged rubber particles
206 PU binder composition
210 Plasticizer
300 PU-rubber reaction mixture
302 Liquid fraction/hardened PU matrix
400 Sports floor (tennis court)
402 Top layer
404 Elastic component (cushioning layer)
406 Support layer
500 Sports floor (running track)
600 Sports floor (shock pad/protective mat)

1. A method of manufacturing an elastic component of a sports floor, the method comprising:
mixing aged rubber particles with a PU binder composition and a plasticizer to provide a PU-rubber reaction mixture; and
allowing the PU-rubber reaction mixture to cure to provide the elastic component.

2. The method of claim 1, wherein the weight ratio of the plasticizer to the rubber particles in the PU-rubber reaction mixture is at least 10:100, in particular at least 15:100, in particular at least 20:100, e.g. 10:100 to 35:100.

3. The method of claim 1, wherein the plasticizer is selected from a group comprising:
a napthenic oil;
an armoatic oil;
a parafinic oil;
vegetable oil, in particular soy bean oil, sunflower oil, palm oil;
diisononyl phthalate (DINP);
1,2-Cyclohexane dicarboxylilc acid diisononyl ester (DINCH);
Stearic acid
Metal salts of stearic acid; and
combinations thereof.

4. The method of claim 1, wherein the plasticizer has a viscosity index of at least 80 cSt or at least 100 cSt.

5. The method of claim 1, wherein the aged rubber particles are selected from a group comprising:
crumb rubber;
aged EPDM particles;
aged styrene-butadiene rubber, SBR, particles;
aged rubber infill of artificial grass;
particles obtained from shredding aged elastic component of a rubber-based floor pavement structure; and
combinations thereof.

6. The method of claim 1,
wherein at least 2%, in particular at least 3.5%, in particular at least 5% by weight of the aged rubber particles have a particle size of less than 0.5 mm; and/or
wherein the aged rubber particles are pre-treated prior to being added to the mixture to ensure that the weight fraction of particles with a size of less than 0.5 mm within the total aged rubber particles is increased to, or maintained at, at least 2% by weight, in particular at least 3.5% by weight, in particular at least 5% by weight.

7. The method of claim 1, wherein the elastic component of the sports floor is selected from a group comprising:
a rubber tile for a sports floor;
a damping layer of a sports floor, in particular of a running track or tennis court;
an elastic support mat to be installed below, within or on top of a sports floor;
a stable mat for animals, in particular a stable mat for horses;
an elastic mat to be reversibly placed on top a sports floor, in particular a bumper plate for weight lifting, protective layers, or a gymnastic mat;
acoustic layers; and
combinations thereof.

8. The method of claim 1,
wherein the PU-binder composition comprises a polyol component and an isocyanate component, wherein the curing comprises allowing the polyol component and the isocyanate component to undergo a polymerization reaction to form a PU matrix that comprises the rubber particles; or
wherein the PU-binder composition comprises an NCO-prepolymer, wherein the curing comprises allowing the prepolymer to undergo a polymerization reaction to form a polyurethane matrix that comprises the rubber particles.

9. The method of claim 8, wherein the NCO-prepolymer is a reaction product of a diol and MDI, wherein in particular the diol has an average molecular weight of 1000 to 4000 g/mol, and/or the diol is Polypropylene glycol, e.g., PPG2000.

10. The method of claim 1, wherein the PU-binder composition has an NCO content of less than 11%, in particular of 4% to 10%, in particular 7% to 9%,
wherein the NCO content is defined as:
$$\frac{weight of NCO groups in the PU - binder composition}{total weight of the PU - binder composition} \times 100 [ \% ] .$$

11. The method of claim 1, wherein the weight ratio of the rubber particles to the plasticizer in the PU-rubber reaction mixture is at least 10:100, in particular at least 15:100, in particular at least 20:100, e.g. 10:100 to 35:100.

12. An elastic component of a sports floor, the component comprising:
aged rubber particles; and
a PU matrix that comprises the rubber particles, the PU matrix having been formed by a PU-rubber reaction mixture comprising the aged rubber particles, a PU binder composition and a plasticizer.

13. The elastic component of claim 12,
wherein the weight ratio of the plasticizer to the rubber particles in the elastic component is at least 10:100, in particular at least 15:100, in particular at least 20:100, e.g. 10:100 to 35:100; and/or
Wherein at least 2%, in particular at least 3.5%, in particular at least 5% by weight of the aged rubber particles have a particle size of less than 0.5 mm.

14. The elastic component of claim 12, wherein the plasticizer has a viscosity index of at least 80 cSt or higher.

15. A sports floor comprising the elastic component of claim 13.
